(19) United States
(12) Patent Application Publication
(10) Pub. No.: US 2014/0238213 A1
(43) Pub. Date: Aug. 28, 2014

(54) METHOD FOR PERFORMING A MECHANICAL OPERATION IN A STRUCTURE COMPRISING TWO LAYERS OF DIFFERENT STIFFNESS

(71) Applicant: Commissariat a l'energie atomique et aux ene alt, Paris (FR)

(72) Inventors: Hubert Moriceau, Saint-Egreve (FR); Maxime Argoud, Lyon (FR); Marc Zussy, Saint-Egreve (FR)

(73) Assignee: Commissariat a l'energie atomique et aux ene alt, Paris (FR)

(21) Appl. No.: 14/348,758

(22) PCT Filed: Oct. 2, 2012
(86) PCT No.: PCT/EP2012/069425

§ 371 Date: Mar. 31, 2014

(30) Foreign Application Priority Data
Oct. 5, 2011 (FR) 11 58994

(51) Int. Cl. B26D 3/00

(52) U.S. Cl. CPC B26D 3/00
USPC 83/861

(57) ABSTRACT

A method for performing at least one mechanical operation on a structure including at least one first layer stacked onto at least a second layer, the first layer including at least one material with a Young's modulus equal to or higher than about 50 GPa and higher than that of at least one material of the second layer, the method including: thinning the first layer, located at least at one area of the structure intended to undergo application of a pressing force upon implementing the mechanical operation; and implementing the mechanical operation including applying the pressing force located on at least one part of the area of the structure.

### TECHNICAL FIELD

The invention relates to a method for performing a mechanical operation in a structure including at least one first rigid layer stacked onto a second less rigid layer, the operation involving applying a pressing force onto the structure, on the first layer side. Such a mechanical operation corresponds for example to cutting, thinning or even trimming the structure.

### STATE OF PRIOR ART

When a mechanical operation such as cutting, thinning or even trimming is desired to be performed, in a structure including a first layer of a few micrometres thickness, for example comprising crystalline silicon, covering a second polymer layer thicker than the first layer, the excessive flexibility of the polymer, which is for example in a rubbery (or rubberized) state, relative to the crystalline silicon can result in irreversible damage in the first silicon layer because of the flexion thereof due to the pressing force applied by a cutting, thinning or trimming tool onto the first layer.

This problem is illustrated in FIG. 1A to 1C in the case of cutting the structure by a blade. Such a structure 10 is shown in FIG. 1A, and includes for example a first layer 12 of crystalline silicon the thickness of which is for example between about 5 μm and 20 μm, secured to a second layer 14 of polymer the thickness of which is for example between about 0.5 mm and 2 mm. During an operation of cutting the structure 10, a sawing tool 16, for example a rotating blade, will apply a pressing force onto the upper face of the first layer 12, perpendicularly to that face (FIG. 1B). Given the flexibility of the second layer 14 which comprises polymer, the first layer 12 is then locally deformed with some bending at the pressing area of the sawing tool 16 on the structure 10, inducing a flexion of the first layer 12 and resulting in irreversible damages in the first layer 12, as for example breaks, peeling of parts of the first layer, cracks, etc. (see FIG. 1C wherein damage 18 are symbolically shown in the first layer 12).

### DISCLOSURE OF THE INVENTION

One aim of the present invention is to provide a new method enabling a mechanical operation to be performed on a structure such as previously described, that is including a first so-called rigid layer, for example comprising a material the average Young's modulus of which is equal to or higher than about 50 GPa, covering a second layer which is more flexible than the first layer and comprising a material the Young's modulus of which is for example lower than about 50 GPa, typically lower than about 1 GPa or lower than about 100 MPa or even lower than about 50 MPa, which involves applying a pressing force, or downforce, onto this structure, but which enables damage to the structure to be avoided.

For this, the invention provides a method for performing at least one mechanical operation on a structure including at least one first layer stacked onto at least a second layer, the first layer comprising at least one material the Young's modulus of which is equal to or higher than about 50 GPa and higher than that of at least one material of the second layer, including at least the steps of:
thinning of the first layer, located at least at one area of the structure intended to undergo application of a pressing force upon implementing the mechanical operation,
implementing the mechanical operation including applying the pressing force located on at least one part of said area of the structure

Thus, by performing beforehand a located thinning of the first layer, damage to the first layer is avoided because at the thinned area, the structure can undergo a high flexion without damaging the first layer. Such a method can be applicable to any mechanical operation type involving pressing onto the structure.

The implementation of the mechanical operation may include use of at least one tool in said area of the structure, the pressure of which onto the structure, upon implementing the mechanical operation, may be performed at a pressing area, or pressing location, of the structure. Such a tool may correspond for example to a sawing blade or even a diamond wheel of a thinning or trimming device. During the implementation of the mechanical operation, pressing the tool can result in a deformation in the structure.

The mechanical operation may include at least cutting and/or thinning and/or trimming of the structure performed at least on and/or next to said area of the structure.

The thinning may be performed, at said area of the structure, throughout the thickness of the first layer. Thus, all the material of the first layer located at said area of the structure is removed.

Alternatively, the thinning may only be performed on part of the thickness of the first layer.

Thus, part of the material of the first layer located at said area of the structure is removed.

The thinned thickness of the first layer may depend on the initial thickness of the first layer and on the relative stiffnesses of the first and second layers of the structure to enable, after thinning, the structure to be flexed, which induces little or no damage within the first layer.

The dimensions of said area of the structure, in a plane parallel to a face of the first layer provided facing the second layer, may be equal to or higher than a depth (or thickness) of penetration of the tool into the second layer (upon implementing the mechanical operation), possibly increased by the tool width in this same plane at the pressing area.

It is also possible that the dimensions of said area of the structure, in the plane parallel to the face of the first layer provided facing the second layer, be equal to or higher than about twice the depth of penetration of the tool into the second layer.

The dimensions of said area of the structure, in the plane parallel to the face of the first layer provided facing the second layer, may be equal to or higher than the sum of twice the depth of penetration of the tool into the second layer and the width of the tool in the same plane at the pressing area.

If the tool does not penetrate the second layer, the dimensions of said area of the structure, in a plane parallel to a face of the first layer provided facing the second layer, may be equal to or higher than the thickness of deformation of the second layer which is generated by the tool pressure, or twice this thickness, possibly increased by the width of the tool at the pressing area.

The thinning of the first layer located at said area of the structure may be performed around at least one portion of the first layer provided in said area of the structure, the mechanical operation including applying the pressing force located onto said portion of the first layer.

In this case, a width of said portion of the first layer may be lower than about three times a width of the tool at the pressing area. This configuration is particularly advantageous when the tool corresponds to a sawing blade.

The first layer may include a thickness between about 0.1 μm and 100 μm, or even between 1 μm and 50 μm, or even 1 μm and 20 μm, and/or the second layer may include a thickness higher than about 500 μm, for example between about 0.5 mm and 2 mm.

The first layer may comprise at least one semi-conductor (for example silicon), and/or the second layer may comprise at least one polymer, for example a rubbery (the Young's modulus of which is for example equal to or lower than about 1 GPa) or rubberized (the Young's modulus of which is for example equal to or lower than about 50 MPa) polymer. The structure may correspond to a microelectronic type substrate.

The pressing force may be applied substantially perpendicular to a face of the first layer provided facing the second layer.

### BRIEF DESCRIPTION OF THE DRAWINGS

The present invention will be better understood upon reading the description of exemplary embodiments given by way of purely indicating purposes and in no way limiting by referring to the appended drawings wherein:

FIGS. 1A to 1C represent performing a cutting mechanical operation according to prior art,

FIGS. 2A to 2C represent the steps of a method for performing a mechanical operation, object of the present invention, according to a particular embodiment,

FIGS. 3 to 5 represent several alternative embodiments of a localized thinning performed during a method for performing a mechanical operation, object of the present invention,

FIGS. 6A, 6B, 7A and 7B represent steps of a method for performing a mechanical operation, object of the present invention, according to other embodiments.

Identical, similar or equivalent parts of the different figures described hereinafter have the same reference numerals so as to facilitate switching from one figure to another.

The different parts shown in the figures are not necessarily drawn at a uniform scale, to make the figures more legible.

The different possibilities (alternatives and embodiments) should be understood as being not mutually exclusive and they can be combined together.

### DETAILED DISCLOSURE OF THE PARTICULAR EMBODIMENTS

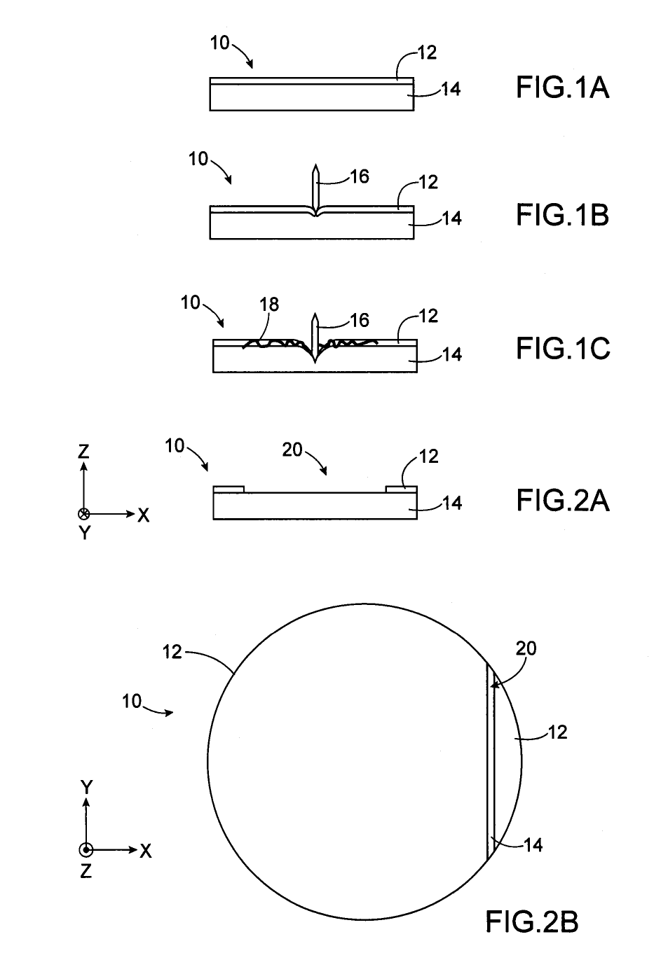

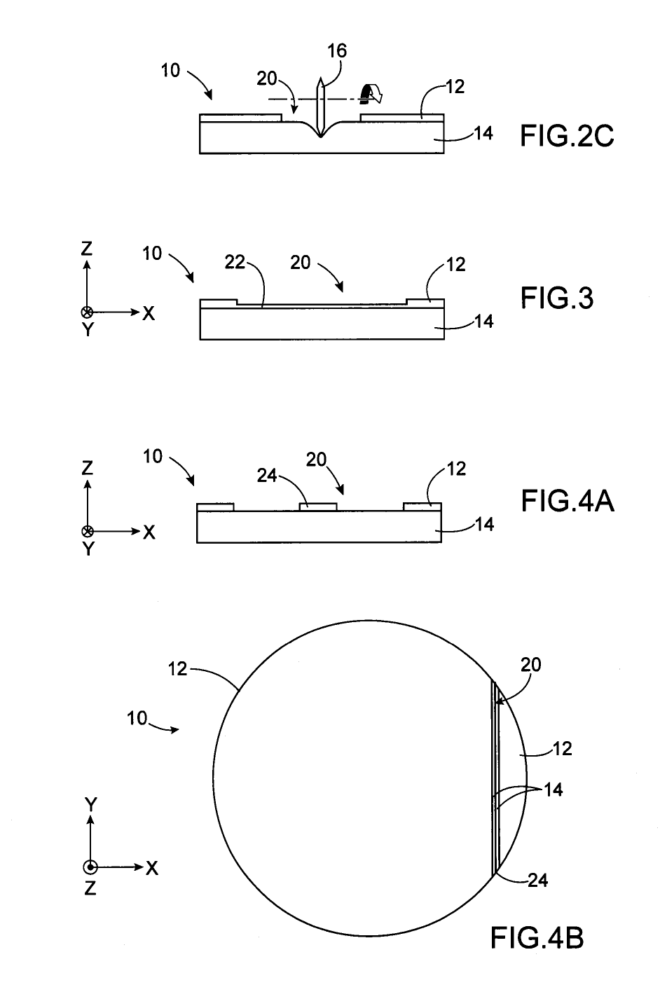

FIGS. 2A to 2C will be referred to which represent the steps of a method for performing a mechanical operation, here a cutting or sawing operation, in the structure 10 which corresponds to that previously described in connection with FIG. 1A, according to a particular embodiment. The structure 10 corresponds to a microelectronic type substrate, that is a substrate onto which microelectronic devices are intended to be made.

As shown in FIGS. 2A and 2B, which respectively correspond to a partial profile cross-section view and a top view of the structure 10, a thinning of the first layer 12 located in an area 20 of the structure 10 is first performed, the cutting mechanical operation being intended to be subsequently performed at this area 20. In the example described here, the thinning is performed throughout the thickness (dimension along the axis Z) of the first layer 12. Thus, at the area 20, the part of the first layer 12 which is initially present is wholly removed, thus uncovering part of the upper surface of the second layer 14. This located thinning forms the area 20 which corresponds to a groove dug in the first layer 12. This located thinning can be performed via different techniques: dry etching, wet etching, laser ablation, etc.

After performing this located thinning, the sawing operation of the structure 10 can be implemented. As shown in FIG. 2C, the sawing tool 16, for example a rotating blade, then comes to mechanically press on the structure 10, at the area 20 which has undergone the located thinning beforehand. This pressure is herein reflected on the structure 10 by a pressing force applied in the area 20 onto the second layer 14, perpendicularly to the face of the second layer 14 which is facing the first layer 12.

Thanks to the located thinning previously performed, the sawing tool 16 is thus in direct contact with the second layer 14. The structure 10 can thus be cut throughout the length of the groove previously performed by thinning, without the first layer 12 breaking or bring damaged due to the pressing force applied by the sawing tool 16 onto the structure 10, because the first layer 12 does not flex or much less than without thinning. Thus, the first layer 12 is kept from possible damages which could be generated by the sawing tool 16 if the first layer 12 were not locally thinned.

Upon performing the thinning, the area 20 is advantageously sized such that its width (dimension along the axis x) is equal to or higher than about twice the depth of penetration of the tool 16 into the second layer 14 during the mechanical operation performed after thinning (in FIG. 2C, this depth of penetration, which corresponds to the down up to which the second layer is cut, corresponds to the distance between the interface of the first layer and the second layer and the low end of the sawing tool 16), possibly increased by the width of the tool 16 at the pressing area onto the structure 10.

In a first alternative shown in FIG. 3, the thinning located at the area 20 is performed through part only of the thickness of the first layer 12. This thinning is for example implemented such that at the area 20, a remaining portion 22 of the first layer 12 still covers the second layer 14. The thickness of the first layer 12 to be thinned can be determined depending on the initial thickness of the first layer 12 and on the relative stiffnesses of the first and second layers, in order to allow, after thinning, a flexion of the structure inducing little or no damage within the first layer 12. Prior tests could be carried out by gradually increasing the thinned thickness until the required result is obtained.

If, during the mechanical operation, the tool does not penetrate the second layer 14 and is only, for example, used to cut the first layer 12 on all or part of its remaining thickness, the width of the area 20 will be advantageously equal to or higher than about twice the thickness of the deformed area of the second layer because of the tool pressing onto the first layer (that is the depth in the second layer 14 down to which deformations are generated by the tool pressing, and beyond which the material of the second layer is no longer deformed by the tool pressing).

The sawing mechanical operation is then implemented analogously to that previously described in connection with FIG. 2C. Even though the sawing tool 16 is pressing onto the portion 22, the located thinning made beforehand enables any damage to the first layer 12 to be avoided. Indeed, a force applied to a portion of a rigid layer only generates damages to the same if this force results in a flexion of this layer beyond some limit. The more reduced the thickness of the layer intended to undergo this flexion, the more reduced the radius of curvature acceptable by this layer without undergoing damages. Thus, in the example described here, since the thickness of the first layer 12 is reduced at the area 20, the portion 22 having a reduced thickness can thus undergo a flexion having a much smaller radius of curvature than that from which the non thinned first layer 12 would undergo irreversible damages.

In a second alternative shown in FIGS. 4A and 4B (a profile cross-section view and a top view of the structure 10 respectively), the thinning located at the area 20 is performed such that a portion 24 of the first layer 12 is preserved in the thinned area 20, advantageously at its centre. This portion 24 thus forms a pressing area of the sawing tool 16 during the implementation of the cutting operation of the structure 10. By pressing the sawing tool 16 onto the portion 24 upon cutting the structure 10, the contact and penetration of the tool 16 into the structure 10 are promoted upon cutting the structure 10. The width of the portion 24 (dimension along the axis X) is for example between about one and three times the width of the sawing tool 16. The portion 24 can have a thickness (dimension along the axis Z) equal to the initial thickness of the first layer 12, but it is also possible that the portion 24 has a thickness lower than the initial thickness of the first layer 12. Once again, such a located thinning can be implemented via dry or wet etching, or even laser ablation.

In this configuration, the total width of the area 20 is for example equal to the width of the portion 24 increased by about twice the depth of penetration of the tool into the second layer 14 (or if the tool does not penetrate the second layer, twice the thickness of the deformed area of the second layer 14 because of the tool pressing onto the portion 24).

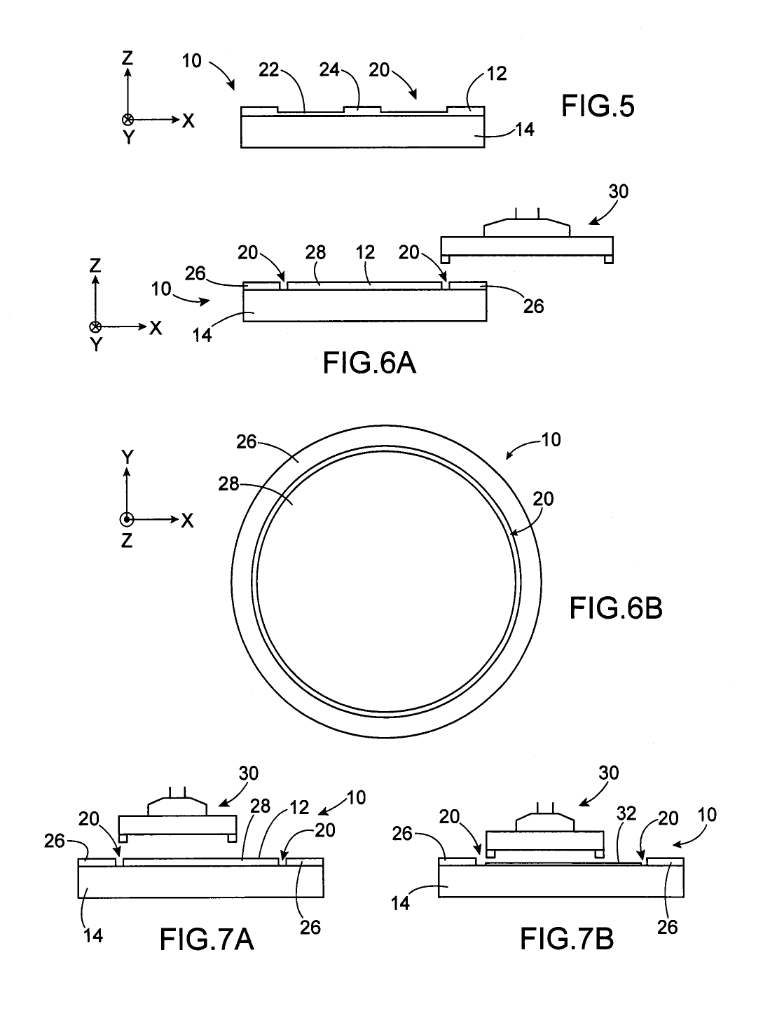

As shown in FIG. 5, it is possible to combine both alternatives previously described in connection with FIGS. 3, 4A and 4B, by performing a thinning located at the area 20 such that the remaining portion 22 of the first layer 12 still covers the second layer 14 at the thinned area 20, and that the portion 24 is also present in the thinned area 20.

The mechanical operation performed can be different from a sawing operation, and corresponds for example to a trimming operation of the structure 10. The implementation of such a trimming is shown in FIGS. 6A and 6B (respectively a profile cross-section view and a top view of the structure 10). The thinned area forms here an area enabling the bounding of a peripheral part 26 of the first layer 12 intended to be removed by the implementation of the trimming operation and of central part 28 of the first layer 12 desired to be preserved. This trimming operation is for example implemented thanks to a tool 30 provided with a diamond wheel enabling the peripheral portion 26 of the first layer 12 to be removed. The tool 30 does not damage the central part 28 thanks to the thinned area 20 made in the structure 10, the tool 30 pressing on the structure in particular at the area 26 to be trimmed. The deformation of the area 28 due to this pressure is thus reduced and does not generate any damage in the area 28. The width of the thinned area 20 is advantageously higher than the thickness of the deformed area of the second layer 14 because of the tool 30 pressing onto the area 26, and advantageously higher than the depth of penetration of the tool 30 into the second layer 14.

In another embodiment, the mechanical operation can correspond for example to a located thinning operation of the structure 10. The implementation of such a thinning is shown in FIG. 7A (before thinning) and FIG. 7B (after thinning). The thinned area 20 forms here an area enabling the bounding of a peripheral part 26 of the first layer 12 the total thickness of which is intended to be preserved and of a central part 28 of the first layer which is desired to be thinned by implementing the thinning operation. This thinning operation is for example implemented thanks to the tool 30 the diamond wheel of which enables all or part of the thickness of the central part 28 of the first layer 12 to be removed (see FIG. 7B, the thinned central part 32). Thanks to the thinned area 20 made beforehand, the thinning of the central part 28 can be performed without damaging the first layer 12 when the tool 30 is contacting with the same. The width of the thinned area 20 will be in this case advantageously higher than the thickness of the deformed area of the second layer 14 because of the tool 30 pressing onto the area 28 and advantageously higher than the depth of penetration of the tool 30 into the second layer 14.

1-13. (canceled)

14. A method for performing at least one mechanical operation on a structure including at least one first layer stacked onto at least a second layer, the first layer including at least one material with a Young's modulus equal to or higher than about 50 GPa and higher than that of at least one material of the second layer, the method comprising:
thinning the first layer, located at least at one area of the structure intended to undergo an application of a pressing force upon implementing the mechanical operation;
implementing the mechanical operation including applying the pressing force located on at least one part of the area of the structure.

15. The method according to claim 14, wherein the mechanical operation includes at least one of a cutting, a thinning, or a trimming of the structure performed at least on or next to the area of the structure.

16. The method according to claim 14, wherein the thinning is performed at the area of the structure, throughout the thickness of the first layer.

17. The method according to claim 14, wherein the implementing the mechanical operation includes using at least one tool in the area of the structure, a pressure of which onto the structure is made at a pressing area of the structure.

18. The method according to claim 17, wherein dimensions of the area of the structure, in a plane parallel to a face of the first layer provided facing the second layer, are equal to or higher than a depth of penetration of the tool into the second layer.

19. The method according to claim 18, wherein the dimensions of the area of the structure, in the plane parallel to the face of the first layer provided facing the second layer, are equal to or higher than about twice the depth of penetration of the tool into the second layer.

20. The method according to claim 19, wherein the dimensions of the area of the structure, in the plane parallel to the face of the first layer provided facing the second layer, are equal to or higher than the sum of twice the depth of penetration of the tool into the second layer and of the width of the tool in the same plane at the pressing area.

21. The method according to claim 17, wherein the thinning of the first layer located at the area of the structure is performed around at least one portion of the first layer provided in the area of the structure, the mechanical operation including applying the pressing force located onto the portion of the first layer.

22. The method according to claim 21, wherein a width of the portion of the first layer is lower than about three times a width of the tool at the pressing area.

23. The method according to claim 14, wherein the first layer has a thickness between about 1 μm and 50 μm

24. The method according to claim 14, wherein the second layer has a thickness between about 0.5 mm and 2 mm.

25. The method according to claim 14, wherein the first layer comprises at least one semi-conductor.

26. The method according to claim 14, wherein the second layer comprises at least one polymer.

27. The method according to claim 14, wherein the Young's modulus of the material of the second layer is lower than about 50 MPa.

28. The method according to claim 14, wherein the pressing force is applied substantially perpendicular to a face of the first layer provided facing the second layer.
